(19) United States
(12) Patent Application Publication
(10) Pub. No.: US 2009/0265707 A1
(43) Pub. Date: Oct. 22, 2009

(54) OPTIMIZING APPLICATION PERFORMANCE ON VIRTUAL MACHINES AUTOMATICALLY WITH END-USER PREFERENCES

(75) Inventors: Alan H. Goodman, Seattle, WA (US); Onur Simsek, Seattle, WA (US); Tolga Yildirim, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/106,817

(22) Filed: Apr. 21, 2008

(51) Int. Cl. G06F 9/46

(52) U.S. Cl. 718/1

(57) ABSTRACT

A virtual machine management/monitoring service can be configured to automatically monitor and implement user-defined (e.g., administrator-defined) configuration policies with respect to virtual machine and application resource utilization. In one implementation, the monitoring service can be extended to provide user-customized alerts based on various particularly defined events that occur (e.g., some memory or processing threshold) during operation of the virtual machines and/or application execution. The user can also specify particularly tailored solutions, which can include automatically reallocating physical host resources without additional user input on a given physical host, or moving/adding virtual machines on other physical hosts. For example, the monitoring service can be configured so that, upon identifying that a virtual machine's memory and processing resources are maxed out and/or growing, the monitoring service adds memory or processing resources for the virtual machine, or adds a new virtual machine to handle the load for the application program.

### CROSS-REFERENCE TO RELATED APPLICATIONS

N/A

### BACKGROUND

1. Background and Relevant Art

Conventional computer systems are now commonly used for a wide range of objectives, whether for productivity, or entertainment, and so forth. One reason for this is that, not only computer systems tend to add efficiency with task automation, but computer systems can also be easily configured and reconfigured over time for such tasks. For example, if a user finds that one or more application programs are running too slowly, it can be a relatively straightforward matter for the user to add more memory (e.g., RAM), add or swap out one or more processors (e.g., a CPU, GPU, etc.), add or improve the current storage, or even add or replace other peripheral devices that may be used to share or handle the workload. Similarly, it can be relatively straightforward for the user to install or upgrade various application programs on the computer, including the operating system. This tends to be true in theory even on large, enterprise scale.

In practice, however, the mere ability to add or upgrade physical and/or software components for any given computer system is often daunting, particularly on a large scale. For example, although upgrading the amount of a memory tends to be fairly simple for an individual computer system, upgrading storage, peripheral devices, or even processors for several different computer systems, often involves some accompanying software reconfigurations or reinstallations to account for the changes. Thus, if company's technical staff were to determine that the present computer system resources in a department (or in a server farm) were inadequate for any reason, the technical staff might be more inclined to either add entirely new physical computer systems, or completely replace existing physical systems instead of adding individual component system parts.

Replacing or adding new physical systems, however, comes with another set of costs, and cannot typically occur instantaneously. For example, one or more of the technical staff may need to spend hours in some cases physically lifting and moving the computer systems into position, connecting each of the various wires to the computer system, and loading various installation and application program media thereon. The technical staff may also need to perform a number of manual configurations on each computer system to ensure the new computer systems can communicate with other systems on the network, and that the new computer systems can function at least as well for a given end-user as the prior computer system.

Recent developments in virtual machine (“VM”) technology have improved or remediated many of these types of constraints with physical computer system upgrades. In short, a virtual machine comprises a set of files that operate as an additional, unique computer system within the confines and resource limitations of a physical host computer system. As with any conventional physical computer system, a virtual machine comprises an operating system and various user-based files that can be created and modified, and comprises a unique name or identifier by which the virtual computer system be found or otherwise communicate on a network. Virtual machines, however, differ from conventional physical systems since virtual machines typically comprise a set of files that are used within a well-defined boundary inside another physical host computer system. In particular, there can be several different virtual machines installed on a single physical host, and the users of each virtual machine can use each different virtual machine as though it were a separate and distinct physical computer system.

A primary difference with physical systems, however, is that the resources allocated to and used by a virtual machine can be assigned and allocated electronically. For example, an administrator can use a user interface to assign and provide a virtual machine with access to one or more physical host CPUs, as well as access to one or more storage addresses, and memory addresses. Specifically, the administrator might delegate the resources of a physical host with 4 GB of RAM and 2 CPUs so that two different virtual machines are assigned 1 CPU and 2 GB of RAM. An end-user of the given virtual machines in this particular example might thus believe they are using a unique computer system that has 1 CPU and 2 GB of RAM.

In view of the foregoing, one will appreciate that adding new virtual machines, or improving the resources of virtual machines, can also be done through various electronic communication means. That is, a system administrator can add new virtual machines within a department (e.g., for a new employee), or to the same physical host system to share various processing tasks (e.g., on a web server with several incoming and outgoing communications) by executing a request to copy a set of files to a given physical host. The system administrator might even use a user interface from a remote location to set up the virtual machine configurations, including reconfiguring the virtual machines when operating inefficiently. For example, the administrator might use a user interface to electronically reassign more CPUs and/or memory/storage resources to virtual machines that the administrator identifies as running too slowly.

Thus, the ability to add, remove, and reconfigure virtual machines can provide a number of advantages when comparing similar tasks with physical systems. Notwithstanding these advantages, however, there are still a number of difficulties when deploying and configuring virtual machines that can be addressed. Much of these difficulties relate to the amount and type of information that can be provided to an administrator pursuant to identifying and configuring operations in the first instance. For example, conventional virtual machine monitoring systems can be configured to indicate the extent of host resource utilization, such as the extent to which one or more virtual machines on the host are taxing the various physical host CPUs and/or memory. Conventional monitoring software might even be configured to send one or more alerts through a given user interface to indicate some default resource utilizations at the host.

In some cases, the monitoring software might even provide one or more automated load balancing functions, which includes automatically redistributing various network-based send/receive functions among various virtual machine servers. Similarly, some conventional monitoring software may have one or more automated configurations for reassigning processors and/or memory resources among the virtual machines as part of the load balancing function. Unfortunately, however, such alerts and automated reconfigurations tend to be minimal in nature, and tend to be limited in highly customized environments. As a result, a system administrator often has to perform a number of additional, manual operations if a preferred solution involves introduction of a new machine, or movement of an existing virtual machine to another host.

Furthermore, the alerts themselves tend to be fairly limited in nature, and often require a degree of analysis and application by the system administrator in order to determine the particular cause of the alert. For example, conventional monitoring software only monitors physical host operations/metrics, but not ordinarily virtual machine operations, much less application program performance within the virtual machines. As a result, the administrator can usually only infer from the default alerts regarding host resource utilization that the cause of poor performance of some particular application program might have something to do with virtual machine performance.

Accordingly, there are a number of difficulties with virtual machine management and deployment that can be addressed.

### BRIEF SUMMARY

Implementations of the present invention overcome one or more problems in the art with systems, methods, and computer program products configured to automatically monitor and reallocate physical host resources among virtual machines in order to optimize performance. In particular, implementations of the present invention provide a widely extensible system in which a system administrator can set up customized alerts for a customized use environment. Furthermore, these customized alerts can be based not only on specific physical host metrics, but also on specific indications of virtual machine performance and application program performance, and even on other sources of relevant information (e.g., room temperature). In addition, implementations of the present invention allow the administrator to implement customized reallocation solutions, which can be used to optimize performance not only of virtual machines, but also of application programs operating therein.

For example, a method of automatically optimizing performance of an application program by the allocation physical host resources among the one or more virtual machines can involve identifying one or more changes in performance of one or more application programs running on one or more virtual machines at a physical host. The method can also involve identifying one or more resource allocations of physical host resources for each of the one or more virtual machines. In addition, the method can involve automatically determining a new resource allocation of physical host resources for each of the virtual machines based on the change in application performance. Furthermore, the method can involve automatically implementing the new resource allocations for the virtual machines, wherein performance of the one or more application programs is optimized.

In addition to the foregoing, an additional or alternative method of automatically managing physical host resource allocations among one or more virtual machines based on information from an end-user can involve receiving one or more end-user configurations regarding allocation of physical host resources by one or more hosted virtual machines. The method can also involve receiving one or more messages regarding performance metrics related to the one or more virtual machines and of the physical host. In addition, the method can involve automatically determining that the one or more virtual machines are operating at a suboptimal level defined by the received one or more end-user configurations. Furthermore, the method can involve automatically reallocating physical host resources for the one or more of the virtual machines based on the received end-user configurations. As such, the one or more virtual machines use physical host resources at an optimal level defined by the received end-user configurations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview schematic diagram in which a virtual machine monitoring service monitors metrics of both a host and one or more virtual machines in accordance with an implementation of the present invention;

FIG. 2A illustrates an overview schematic diagram in which the virtual machine monitoring service uses one or more user configurations to reallocate resources used by the one or more virtual machines on a physical host in accordance with an implementation of the present invention;

FIG. 2B illustrates an overview schematic diagram in which the virtual machine monitoring service uses one or more user-specified configurations to create a new virtual machine on the physical host in accordance with an implementation of the present invention;

FIG. 3 illustrates a flowchart of a method comprising a series of acts in which a monitoring service automatically reallocates resources in accordance with an implementation of the present invention; and

FIG. 3 illustrates a flowchart of a method comprising a series of acts in which a monitoring service automatically optimizes application program performance with end-user configurations in accordance with an implementation of the present invention.

### DETAILED DESCRIPTION

Implementations of the present invention extend to systems, methods, and computer program products configured to automatically monitor and reallocate physical host resources among virtual machines in order to optimize performance. In particular, implementations of the present invention provide a widely extensible system in which a system administrator can set up customized alerts for a customized use environment. Furthermore, these customized alerts can be based not only on specific physical host metrics, but also on specific indications of virtual machine performance and application program performance, and even on other sources of relevant information (e.g., room temperature). In addition, implementations of the present invention allow the administrator to implement customized reallocation solutions, which can be used to optimize performance not only of virtual machines, but also of application programs operating therein.

To these and other ends, implementations of the present invention include the use a framework that a user can easily extend and/or otherwise customize to create their own rules. Such rules, in turn, can be used for various, customized alerting functions, and to ensure efficient allocation and configuration of a virtualized environment. In one implementation, for example, the components and modules described herein can thus provide for automatic (and manual) recognition of issues within virtualized environments, as well as solutions thereto. Furthermore, users can customize the policies for these various components and modules, whereby the components and modules take different action depending on the hardware or software that is involved in the given issue.

In addition, and as will be understood more fully herein, implementations of the present invention further provide automated solutions for fixing issues, and/or for recommending more efficient environment configurations for virtualized environments. Such features can be turned “on,” or “off.” When enabled, the customized rules allow the monitoring service to identify the resources for a user-specified condition. Once any of the conditions arise, the monitoring service can then provide an alert (or “tip”) that can then be presented to the user. Depending on the configuration that the user has specified in the rules, these alerts or tips can be configured to automatically implement the related resolution, and/or can require user initiation of the recovery process. In at least one implementation, an application-specific solution would mean a solution for a virtual machine that is running a mail server can be different that a solution for a virtual machine that is running a database server.

In addition, and as previously mentioned, such customizations can also extend to specific hardware configurations that are identified and determined by the end-user (e.g., system administrator). In on implementation, for example, an end-user can customize an alert so that when the number of transactions handled by certain resources reaches some critical point, the monitoring service can deploy a virtual machine that runs a web server with the necessary applications inside. Accordingly, implementations of the present invention allow users and administrators to solve issues proactively, or reactively as needed, by using information about the specific hardware and software that is running, and even about various environmental factors in which the hardware and software are running, even in highly customized environments.

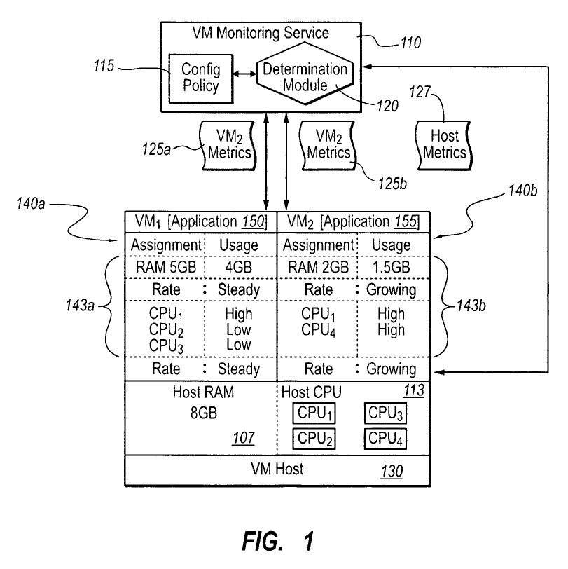

Referring now to the figures, FIG. 1 illustrates an overview schematic diagram in which one or more virtual machines handle execution of various applications in a computerized environment. For example, FIG. 1 shows that virtual machine 140a (“VM₁”) is assigned to handle or execute “Application 150,” while virtual machine 140b (“VM₂”) is assigned to handle “Application 155.” Applications 150 and 155 in this example can be virtually any application program, such as an email or web server, a database server, or even an end-user application.

In addition, FIG. 1 shows that virtual machines 140a and 140b are hosted by physical host 130 (or “VM Host 130”). That is, physical host 130 provides the physical resources (e.g., memory, processing, storage, etc.) on which the virtual machines 140 are installed, and with which the virtual machines 140 execute instructions. As shown, for example, physical host 130 comprises at least a set of memory resources 107 and processing resources 113. Specifically, FIG. 1 shows that the illustrated memory resources comprise 8 GB of random access memory (RAM), and that the processing resources 113 comprise at least four different central processing units (CPU), illustrated as “CPU₁,” “CPU₂,” “CPU₃,” and “CPU₄.”

Of course, one will appreciate that this particular configuration is not meant to be limiting in any way. That is, one will appreciate that host 130 can further comprise various storage resources, whether accessible locally or over a network, as well as various other peripheral components for storage and processing. Furthermore, implementations of the present invention are equally applicable to physical hosts that comprise more or less than the illustrated resources. Still further, there can be more than one physical host that is hosting one or more still additional virtual machines in this particular environment. Only one physical host, however, is shown herein for purposes of convenience in illustration.

In any event, and as previously mentioned, FIG. 1 further shows that the illustrated physical host 130 resources 107, 113, are assigned in one form or another to the hosted virtual machines 140(a-b). For example, FIG. 1 shows that virtual machine 140a is assigned or otherwise configured to use 5 GB of RAM, and CPUs 1, 2, and 3. By contrast, FIG. 1 shows that virtual machine 140b has been assigned, or has otherwise been configured to use 2 GB of RAM, and CPUs 1, and 4. In this particular example, therefore, the administrator has assigned processing resource 113 so that virtual machines 140a and 140b both share at least one CPU (i.e., “CPU₁”). By contrast, FIG. 1 shows that the total amount of memory resources 107 allocated to the virtual machines 140 will typically only add up to the same or less than the total number of memory resources 107 available.

Thus, one will appreciate that at least one “trigger” for reallocating resources can be the memory requirements of any given virtual machine and/or corresponding application program operating therein, particularly considered in the context of other virtual machines and applications at host 130. Along these lines, FIG. 1 shows that monitoring service 110 continually receives information regarding performance of the virtual machines 140(a/b), application programs (x/y), and/or host 130. For example, FIG. 1 shows that monitoring service 110 receives one or more messages 125a and 125b that include information/metrics related directly to the performance of the various virtual machines 140a and 140b (and/or corresponding applications 150 and 155), respectively, at physical host 130. Similarly, FIG. 1 shows that monitoring service 110 also monitors and receives one or more messages 127 regarding performance metrics of physical host 130.

As a preliminary matter, the figures illustrate VM monitoring service 110 as a single component, such as a single application program. One will appreciate, however, that, monitoring service 110 can comprise several different application components that are distributed across multiple different physical servers. In addition, the functions of monitoring various metric information, receiving and processing end-user policy information, and implementing policies on the various physical hosts can be performed by any of the various monitoring service 110 components at different locations. Accordingly, the present figures illustrate a single service component for handling these functions by way of convenience in explanation.

In any event, this particular example of FIG. 1A shows that the metrics in message 125a can include information that virtual machine 140a is using about 4 GB of the assigned 5 GB of memory resources while executing Application 150. In addition, metrics 125a can indicate that virtual machine 140a is using CPU₁ at a relatively high rate while executing this application, but otherwise using CPU₂ and CPU₃ at relatively low rates. Metrics 125a can further indicate that the rate of usage by virtual machine 140a of both memory and processing resources (143a) in this case is holding “steady.” In addition to this information, metrics 125a can further include information regarding the extent to which Application 150 is operating, such as whether it is operating too slowly on the assigned resources, or as expected or preferred.

By contrast, FIG. 1 shows that metrics 125b received with respect to virtual machine 140b might paint a different picture. For example, the metrics in message 125b can include information that virtual machine 140b is using 1.5 GB of the assigned 2 GB of memory, and that virtual machine 140b is using CPU₁ and CPU₄ at a relatively high rate. Furthermore, the metrics in message 125b can indicate that virtual machine 140b is using the assigned memory resources and processing resources (143b) at a growing rate. Still further, as discussed above for virtual machine 140a, the metrics of message 125b can include other information about the performance of Application 155, including whether this application is operating at an optimal or suboptimal rate.

In addition, one will appreciate that there can many additional types of metric information beyond those specifically described above. As understood herein, many of these metrics can be heavily end-user customized based on the user's knowledge of a particular physical or virtual operating environment. For example, the end-user may have particular knowledge about the propensity of a particular room where a set of servers are used to rise in temperature. The end-user could then configure the metric messages 125, 127 to report various temperature counter information, as well. In other cases, the end-user could direct such information from some other third-party counter that monitors environmental factors and reports directly to the monitoring service 110. Thus, not only can the metric information reported to monitoring service 110 be variedly widely, but the monitoring service 110 can also be configured to receive and monitor relevant information from a wide variety of different sources, which information could ultimately implicate performance of the virtual machines 143 and/or physical hosts 130.

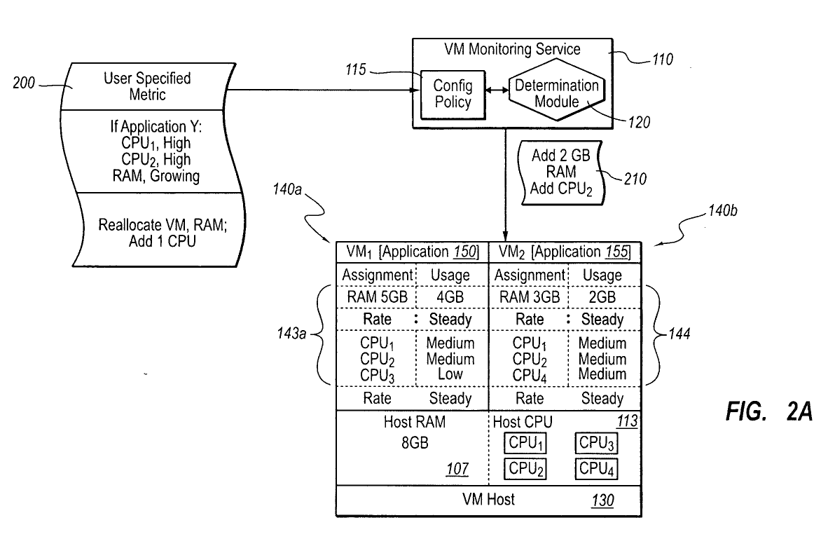

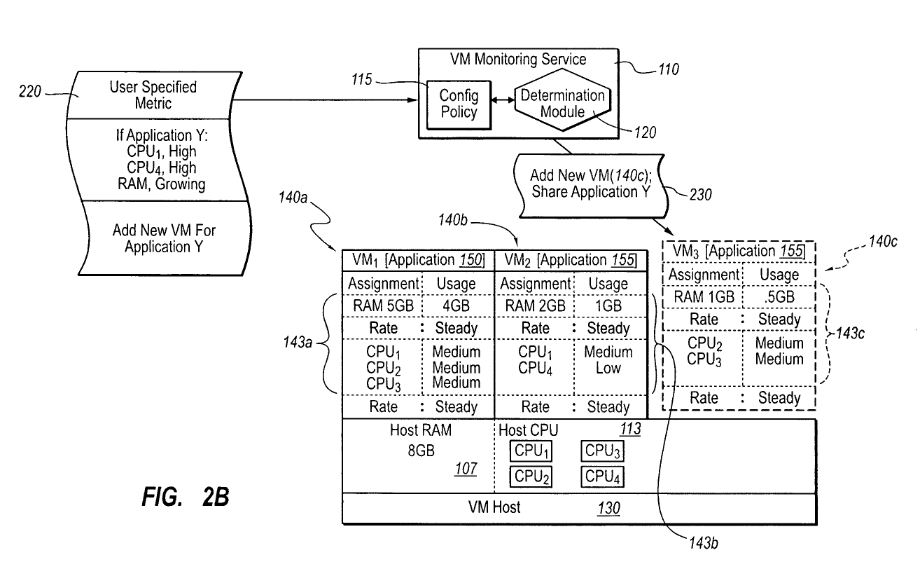

In any event, FIG. 1 shows that monitoring service 110 can comprise a determination module 120, and one or more configuration policies 115 for reviewing triggers/alerts, and for solving problems associated therewith. As understood more fully herein, the determination module 120 processes the variously received metric messages in light of the configuration policies 115. The configuration policies 115 can include a number of default triggers and solutions, such as to provide an alert any time all of the physical host 130 processing units are being maxed out at the same time. The configuration policies 115 can also store or provide any number or type of end-user configurations regarding triggers/alerts, such as described more fully with respect to FIGS. 2A and 2B. The end-user configurations can be understood as supplementing or change the default solutions, and can also or similarly include any one or more of providing an automated alert (e.g., through a user interface) to an end-user/administrator, and/or automatically adjusting the resources allocated to the various virtual machines.

For example, FIG. 2A illustrates an overview schematic diagram in which the virtual machine monitoring service 110 automatically reallocates resources used by virtual machines 140a and 140b. In this particular example, a user (e.g., system administrator) provides one or more messages 200 comprising end-user triggers, policies, and/or configurations for virtual machine and/or application program operations to monitoring service 110. The monitoring service 110, in turn, receives these one or more messages 200 and stores the corresponding information in the configuration policy 115.

FIG. 2A further illustrates that message 200 comprises a set of user-defined triggers or parameters that define operation and performance of Application 155 within acceptable constraints, or otherwise for the performance of virtual machine 140b when running/executing Application 155. In particular, FIG. 2A shows that message 200 indicates that, when Application 155 is running, if CPU₁ and CPU₂ are running high, and if the memory usage is “growing,” monitoring service 110 should reallocate virtual machine resources (or schedule a reallocation). In this particular case, message 200 indicates that reallocating host 130 resources includes changing the RAM allocation and assigning an additional processor. In such a case, therefore, one will appreciate that the triggers can be set to reallocate resources (or schedule a reallocation) in anticipation of future problems, or before a problem occurs that could cause a crash of some sort.

As a result, when determination module 120 detects (e.g., comparing metrics 125b with configuration policy 115) that these particularly defined conditions are met, determination module 120 automatically reallocates the memory and processing resources in accordance with message 200. For example, FIG. 2A shows that, in this particular example, monitoring service 110 sends one or more sets of instructions 210 to host 130 to add 2 GB of RAM and assign CPU₂ to virtual machine 140b. This reallocation of resources can occur automatically, and without additional manual input from the administrator, if desired. In any case, FIG. 2A shows that virtual machine 140b now has 4 GB of assigned RAM, and further comprises an assignment to use each of CPU₁, CPU₂, and CPU₄.

Accordingly, FIG. 2A further shows that the solution corresponding to end-user configuration message 200 essentially solves the instant problem shown previously by FIG. 1. That is, FIG. 2A shows that virtual machine 140b is now using 2 of the 3 newly assigned GB of RAM at a “steady” rate, and that virtual machine 140b is using each of CPU₁, CPU₂, and CPU₄ at a relatively “medium” and similarly “steady” level. One will further appreciate that this means that virtual machine 140b has now been optimized for the performance of Application 155 therein.

Simply reallocating resources for existing virtual machines, however, is only one way to optimize resource utilization by virtual machines, and accompanying application performance therein. In some cases, for example, it may be preferable to reallocate resources by adding a new virtual machine, whether on host 130, or on some other physical host system (not shown), or even moving an existing virtual machine to another host. For example, FIG. 2B illustrates an implementation of the present invention in which the end-user specifies that monitoring service add a new virtual machine 140(c) when detecting certain user-specified parameters/metrics.

For example, FIG. 2B illustrates an implementation in which the user provides one or more messages 220, which comprise user-defined configurations to reallocate resources and create a new virtual machine (e.g., 140c) in response to certain user-defined triggers/criteria present at host 130. As previously described, such triggers can be set relatively low so that they occur before any actual problem occurs (i.e., while some metric “grows” up to or past a certain user-specified limit). As shown in FIG. 2B, for example, message 220 indicates that, with respect to the operation of Application 155, if CPU₁ and CPU₄ are running at relatively “high” levels, and the memory usage is “growing,” then monitoring service 110 should add a new virtual machine for Application 155. This new virtual machine (e.g., 140c) can be on the original host 130, or placed on another physical host (not show).

In either case, the load needed to run Application 155 would then be shared by two different virtual machines. Again, as previously stated with FIG. 2A, this user-specific configuration information 220 is sent to monitoring service 110, and further stored with other configuration policies 115. As a result, when determination module determines (e.g., from metrics 125b) in this case that the triggers in message 220 have been met, monitoring service 110 can then send a set of one or more instructions 230 to add a new virtual machine to host 130.

In particular, FIG. 2B shows that virtual machine monitoring service 110 sends one or more instructions 230 to host 130, which in turn cause physical host 130 to create a new virtual machine 140c. In this example, the new virtual machine 140c is simply set up with the remaining available resources (i.e., allocation 143c), and thus is set up in this case with 1 GB of assigned RAM. Furthermore, the instructions 230 include a request to allocate to the new virtual machine 140c (i.e., VM₃) one of the CPUs, such as CPU₂ and CPU₃, which heretofore have not been shared between virtual machines 140a and 140b.

Of course, one will appreciate that instructions 230 could further include some additional reallocations of memory resources 107 and processing resources 113 among all the previously existing virtual machines 140a and 140b. For example, in addition to adding new virtual machine 140c, monitoring service could include instructions to drop/add, or otherwise alter the resource allocations 143a and/or 143b for virtual machines 140a and 140b. Monitoring service 110 could send such instructions regardless of whether adding new virtual machine 140c to host 130 or to another physical host (not shown).

In any event, and as with the solution provided by instructions 210, the solution provided by instructions 230 result in a significant decrease in memory and CPU usage for virtual machine 140b, since the workload used by Application 155 is now shared over two different virtual machines. Specifically, FIG. 2B shows that virtual machines 140a, 140b, and 140c are now operating within their assigned memory and processing resource allocations, and otherwise holding at a relatively acceptable and steady rate.

Of course, one will appreciate that there can still be several other ways that monitoring service 110 reallocates resources. For example, monitoring service 110 can be configured to iteratively adjust resource allocations over some specified period. In particular with respect to FIG. 2A, monitoring service 110 might receive a new set of metrics in one or more additional messages 125, 127, which indicate that the new resource allocation (from instructions 210) did not solve the problem for virtual machine 140b, and that virtual machine 140b is continuing to max out its allocation (now 144) of processing and memory resources.

The monitoring service 110 might then reallocate the resources of both virtual machine 140a and 140b (again) on a recurring, iterative basis in conjunction with some continuously received metrics (e.g., 125) to achieve an appropriate balance in resources. For example, the monitoring service 110 could automatically downwardly adjust the memory and processing assignments for virtual machine 140a, while simultaneously and continuously upwardly adjusting the memory and processing resources of virtual machine 140b. If the monitoring service 110 could not achieve a balance, the monitoring service might then move virtual machine 140b to another physical host, or provide yet another alert (e.g., as defined by the user) that indicates that the automated solution was only partly effective (or ineffective altogether). In such a case, rather than automatically move the virtual machine 140b, monitoring service 110 could provide a number of potential recommendations, including that the user request a move of the virtual machine 140b to another physical host.

Along similar lines, monitoring service 110 can be configured by the end-user to continuously adjust resource assignments downwardly on a period basis any time that the monitoring service identifies that a virtual machine 140 is rarely using its resource allocations. In addition, the monitoring service 110 can continually maintain a report of such activities across a large farm of physical hosts 130, which can allow the monitoring service 110 to readily identify where new virtual machines can be created, as needed, and/or where virtual machines can be moved (or where application programs assignments can be assigned/shared). Again, since each of these solutions can be provided on a highly configurable and automated basis, such solutions can save a great deal of effort and time for a given administrator, particularly in an enterprise environment.

One will appreciate, therefore, that the components and mechanisms described with respect to FIGS. 1-2B provide a number of different means for ensuring effective and efficient virtual machine operations. Furthermore, and perhaps more importantly, the components and mechanisms described with respect to FIGS. 1-2B provide a number of different and alternative means for automatically optimizing the performance of various application programs operating therein.

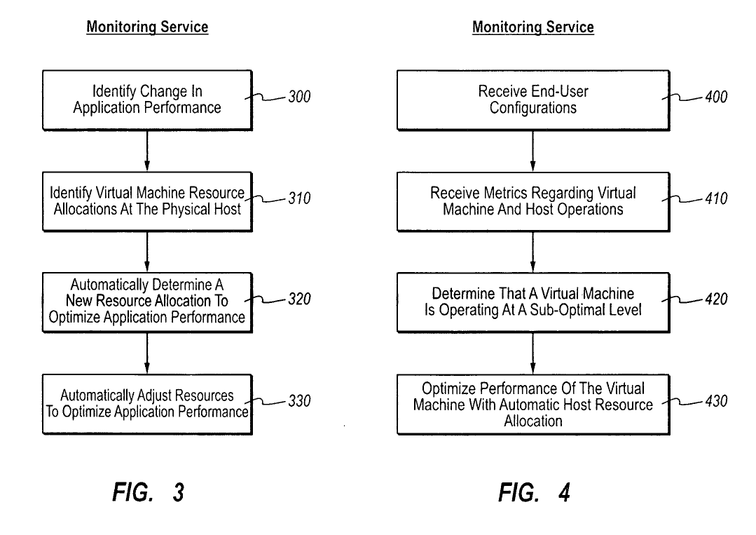

In addition to the foregoing, implementations of the present invention can also be described in terms of flow charts comprising one or more acts in a method for accomplishing a particular result. For example, FIG. 3 illustrates a method from the perspective of monitoring service 110 for monitoring and automatically adjusting resources for the virtual machines to optimize application performance. Similarly, FIG. 4 illustrates a method from the perspective of the monitoring service 110 for using end-user configurations to automatically reallocating virtual machine resources for similar optimizations. The methods of FIGS. 3 and 4 are described more fully below with reference to the components and diagrams of FIG. 1 through 2B.

For example, FIG. 3 shows that a method from the perspective of monitoring service 110 can comprise an act 300 of identifying changes in application performance. Act 300 includes identifying one or more changes in performance of one or more application programs running on one or more virtual machines at a physical host. For example, FIG. 1 shows that virtual machine monitoring service 110 can receive one or more messages 125a, 125b comprising metric information that indicates operations at one or both of the virtual machines 140 and the physical host 130. These messages (and the corresponding performance metrics) with respect to the virtual machines 140 can further include information about application program 150, 155 operations therein.

FIG. 3 also shows that the method from the perspective of monitoring service 110 can comprise an act 310 of identifying virtual machine resource allocations at the physical host. Act 310 includes identifying one or more resource allocations of physical host resources for each of the one or more virtual machines. For example, messages 125 and 127 can further indicate the available memory resources 107 and processing resources 113 at the physical host 113, as well as the individual resource allocations 143a-b by the one or more virtual machines.

In addition, FIG. 3 shows that the method from the perspective of monitoring service 110 can comprise an act 320 of determining a new resource allocation to optimize application program performance. Act 320 includes automatically determining a new resource allocation of physical host resources for each of the virtual machines based on the change in application performance. For example, as shown in FIG. 1, virtual machine monitoring service 110 identifies from the received metrics 125, 127 through determination module 120 that execution of application 150 at VM₁ 140a is causing this virtual machine to use its RAM and CPU allocations at a relatively steady rate. By contrast, monitoring service 110 identifies from the received metrics 125, 127 through determination module 120 that execution of application 155 at VM₂ 140b is not only growing in its resource allocations, but may be maxed out therewith.

Furthermore, FIG. 3 shows that the method from the perspective of monitoring service 110 can comprise an act 330 of automatically adjusting resources for the virtual machines. Act 330 includes automatically implementing the new resource allocations for the virtual machines, wherein performance of the one or more application programs is optimized. For example, FIGS. 2A and 2B illustrate that virtual machine monitoring service 110 can use user-specified metrics and solutions (200, 220) not only to automatically increase the allocation of resources for VM₂ 140b, which is running Application 155, but also to create a new virtual machine 140c, which can also be used to run Application 155 in tandem with VM₂ 140b.

In addition to the foregoing, FIG. 4 illustrates an additional or alternative method from the perspective of the monitoring service 110 of optimizing virtual machine performance on a physical host in view of end-user configurations. Act 400 includes receiving one or more end-user configurations regarding allocation of physical host resources by one or more hosted virtual machines. For example, FIGS. 2A and 2B show that a user (e.g., an administrator) provides one or more end-user configurations 200, 220, which instruct the virtual machine monitoring service 110 what to do upon identifying various resource utilizations by the virtual machines. As shown in FIG. 2A, the monitoring service 110 is instructed to reallocate resource among existing virtual machines in one implementation, while, in FIG. 2B, the monitoring service 110 is instructed to reallocate resources by creating a new virtual machine.

FIG. 4 also shows that the method from the perspective of the monitoring service 110 can comprise an act 410 of receiving metrics regarding virtual machine operations. Act 410 includes receiving one or more messages regarding performance metrics related to the one or more virtual machines and of the physical host. For example, as previously described in respect to FIG. 1, virtual machine monitoring service 110 receives messages 125a and 125b, which can include the various metrics regarding the level of performance of the given virtual machines 140 on the physical host.

In addition, FIG. 4 shows that the method from the perspective of the monitoring service 110 can comprise an act 420 of determining that a virtual machine is operating at a suboptimal level. Act 420 includes automatically determining that the one or more virtual machines are operating at a suboptimal level defined by the received one or more end-user configurations. For example, FIGS. 2A and 2B both show that the virtual machine monitoring service 110 can use determination module 120 to compare user-defined parameters stored in configuration policy 115 with the metric information received in messages 125, 127, etc. Such information can include whether the virtual machine is maxing out its memory and/or processing resources (and even storage resources), as well whether the rate of usage is growing, or otherwise holding steady.

Furthermore, FIG. 4 shows the method from the perspective of the monitoring service 110 can comprise an act 430 of optimizing performance of the virtual machine by automatically reallocating the physical host resources. Act 430 includes and automatically reallocating physical host resources for the one or more of the virtual machines based on the received end-user configuration, wherein the one or more virtual machines use physical host resources at an optimal level defined by the received end-user configurations. For example, FIGS. 2A and 2B illustrate various implementations in which the virtual machine monitoring service 110 sends various instructions 210, 230 to either increase the resource utilization for one or more existing virtual machines, or to otherwise create a new virtual machine. Of course, one will appreciate that such instructions can also include combinations of the foregoing in order (e.g., changing existing resource allocations, and creating a new virtual machine) in order to meet the user-defined parameters.

Accordingly, implementations of the present invention provide a number of components, modules, and mechanisms for ensuring that virtual machines, and corresponding application programs executing therein, can continue to operate at an efficient level with minimal or no human interaction. Specifically, implementations of the present invention provide an end-user (e.g., an administrator) with an ability to tailor resource utilization to specific configurations of virtual machines. In addition, implementations of the present invention provide the end-user with the ability to receive customized alerts for specific, end-user identified operations of the virtual machines and application programs. These and other features, therefore, provide the end-user with the added ability to automatically implement complex resource allocations without otherwise having to take such conventional steps of physically/manually adding, removing, or updating various hardware and software-based resources.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a monitoring service in a computerized environment comprising one or more virtual machines operating on one or more physical hosts, and one or more application programs executing on the one or more virtual machines, a method of automatically optimizing performance of an application program by the allocation physical host resources among the one or more virtual machines, comprising the acts of:
identifying one or more changes in performance of one or more application programs running on one or more virtual machines at a physical host;
identifying one or more resource allocations of physical host resources for each of the one or more virtual machines;
automatically determining a new resource allocation of physical host resources for each of the virtual machines based on the change in application performance; and
automatically implementing the new resource allocations for the virtual machines, wherein performance of the one or more application programs is optimized.

2. The method as recited in claim 1, further comprising an act of receiving one or more performance metrics for the physical host.

3. The method as recited in claim 2, further comprising an act of receiving one or more performance metrics for each virtual machine that is running on the physical host.

4. The method as recited in claim 3, wherein the one or more performance metrics for each virtual machine comprises performance information for each application program being executed by each of the one or more virtual machines.

5. The method as recited in claim 4, wherein the act of automatically determining a new resource allocation further comprises determining a change in a memory resource allocation and a processing resource allocation for an existing virtual machine at the physical host.

6. The method as recited in claim 5, wherein the determination for the memory and processing resource change is made based on a user-specified configuration.

7. The method as recited in claim 6, wherein the user-specified configuration changes a default configuration for responding to the application performance change.

8. The method as recited in claim 1, wherein the act of automatically determining a new resource allocation further comprises determining that a new virtual machine needs to be created.

9. The method as recited in claim 6, further comprising assigning execution of the one or more application programs having the identified performance change to the one or more original virtual machines on which the application was executed and to the new virtual machine.

10. The method as recited in claim 6 wherein the act of automatically determining a new resource allocation further comprises the acts of:
creating an alternate resource allocation of an existing virtual machine; and
creating a different resource allocation for the new virtual machine.

11. The method as recited in claim 6, wherein the act of automatically implementing the new resource allocations further comprises an act of creating a new virtual machine at a new physical host that is different from the original physical host at which the application performance change is identified.

12. The method as recited in claim 1, wherein the act of automatically determining a new resource allocation further comprises determining that an existing virtual machine needs to be moved to another physical host.

13. The method as recited in claim 12, wherein the act of automatically implementing the new allocation further comprises the acts of:
identifying another physical host that has sufficient resources for executing the identified one or more application programs; and
automatically moving the existing virtual machine to the other physical host.

14. The method as recited in claim 13, further comprising an act of automatically changing a prior resource allocation for the moved virtual machine at the other physical host, wherein the moved virtual machine has a new resource allocation for executing the identified application program at the other physical host.

15. At a monitoring service in a computerized environment comprising one or more virtual machines operating on one or more physical hosts, and one or more application programs executing on the one or more virtual machines, a method of automatically managing physical host resource allocations among the one or more virtual machines based on information from an end-user, the virtual machines, and the physical host, comprising the acts of:
receiving one or more end-user configurations regarding allocation of physical host resources by one or more hosted virtual machines;
receiving one or more messages regarding performance metrics related to the one or more virtual machines and of the physical host;
automatically determining that the one or more virtual machines are operating at a suboptimal level defined by the received one or more end-user configurations; and
automatically reallocating physical host resources for the one or more of the virtual machines based on the received end-user configurations, wherein the one or more virtual machines use physical host resources at an optimal level defined by the received end-user configurations.

16. The method as recited in claim 15, wherein the received one or more end-user configurations change one or more default configurations in a configuration policy for the monitoring service.

17. The method as recited in claim 15, wherein the one or more end-user configurations dictate that a new virtual machine is to be created in response to one or more of the performance metrics identified in the received one or more messages.

18. The method as recited in claim 15, wherein the one or more end-user configurations dictate that one of the one or more virtual machines at the physical host needs to be moved to another physical host with available resources for executing a particular application program.

19. The method as recited in claim 15, wherein the act of automatically reallocating physical host resources comprises changing an existing allocation by adding one or more processors and one or more memory addresses of the physical host to create a new allocation for the virtual machine.

20. At a monitoring service in a computerized environment comprising one or more virtual machines operating on one or more physical hosts, and one or more application programs executing on the one or more virtual machines, a computer program storage product having computer-executable instructions stored thereon that, when executed, cause one or more processors in the computerized environment to perform a method comprising:
identifying one or more changes in performance of one or more application programs running on one or more virtual machines at a physical host;
identifying one or more resource allocations of physical host resources for each of the one or more virtual machines;
automatically determining a new resource allocation of physical host resources for each of the virtual machines based on the change in application performance; and
automatically implementing the new resource allocations for the virtual machines, wherein performance of the one or more application programs is optimized.
